(19) United States
(12) Patent Application Publication
(10) Pub. No.: US 2011/0303618 A1
(43) Pub. Date: Dec. 15, 2011

(54) REUSABLE WATER FILTER SYSTEMS AND METHODS

(76) Inventors: Glenn Cueman, Denver, NC (US); Arvind S. Patil, Davidson, NC (US); Barnwell S. Ramsey, Huntersville, NC (US)

(21) Appl. No.: 13/147,499

(22) PCT Filed: Oct. 22, 2009
(86) PCT No.: PCT/US09/61694

§ 371 Date: Aug. 2, 2011

Related U.S. Application Data
(60) Provisional application No. 61/107,361, filed on Oct. 22, 2008.

(51) Int. Cl. C02F 1/28; B01D 27/00; B01D 27/08; B01D 35/00

(52) U.S. Cl. 210/767; 210/232; 210/282

(57) ABSTRACT

The present disclosure provides reusable water filter systems and methods by modifying the design of the plastic housing in such a way so that a disposable sachet with treatment media can be used in it without allowing any bypassing of the untreated water. The present invention provides reusable water filter systems and methods for use in water pitchers and/or faucets including reusable water filter cartridges for gravity flow, reusable water filter cartridges for water pressure systems, disposable sachets (pods) with treatment material for use in the reusable water filter cartridges, molded blocks with treatment material for use in the reusable water filter cartridges, and an associated method of use. Advantageously, the present invention solves the problem of disposing of millions of plastic pitcher filter cartridges.

### CROSS-REFERENCE TO RELATED APPLICATION(S)

The present non-provisional patent application/patent claims the benefit of priority of U.S. Provisional Patent Application No. 61/107,361, filed on Oct. 22, 2008, and entitled “REUSABLE WATER FILTER SYSTEMS AND METHODS,” the contents of which are incorporated in full by reference herein.

### FIELD OF THE INVENTION

The present invention relates generally to water filters. More particularly, the present invention provides reusable water filter systems and methods for use in water pitchers and/or faucets including reusable water filter cartridges for gravity flow, reusable water filter cartridges for water pressure systems, disposable sachets (pods) with treatment material for use in the reusable water filter cartridges, molded blocks with treatment material for use in the reusable water filter cartridges, and an associated method of use.

### BACKGROUND OF INVENTION

Water quality is an issue that is of continuing concern. Despite the continuing efforts of the Environmental Protection Agency (EPA) and state and local water agencies, often water that is used for drinking, cooking, bathing, and the like is far from pure. For example, if water is supplied by a well, it could be affected by contaminants in the ground water. Even if water is supplied through a municipal water treatment facility, there are many contaminants that may slip through. Some of these contaminants are not considered harmful, e.g., they only do things like stain teeth, or give water an unpleasant odor, taste or appearance. To complicate things still further, the very chemicals that are put in water to kill harmful bacteria leave traces in the water, and make it unhealthy or unpleasant for bathing or drinking. Accordingly, home water filters are being used on a wide scale.

One common mechanism for home water filters includes granular activated carbon filtering: a form of activated carbon with a high surface area that absorbs many compounds including many toxic compounds. Water passing through activated carbon is commonly used in municipal regions with organic contamination, bad taste, odors, or the like. Many household water filters and fish tanks use activate carbon filters to further purify the water.

Filter cartridges used in drinking water pitchers and attached to faucets to improve the taste of the water and/or remove contaminants are made of plastic housings with treatment media enclosed in them with porous tops and bottoms to allow untreated water to enter from the top and treated filtered water passing through the media to flow out of the cartridges from pores on the bottom. These filter cartridges are very popular and they are used and discarded in substantial quantities every year. This is creating an environmental disposal problem of major proportions.

Related, there is some prior art in the area of coffee brewing where disposable filter pads are used. However, the prior art fails to provide a mechanism to ensure that there is no bypass where water can escape without going through the treatment media. U.S. Pat. No. 7,258,884 discloses a method having the steps of: providing an electric coffee brewing machine; providing a single-use, disposable brew basket, inserting the disposable brew basket into the electric coffee brewing machine; brewing a single cup of coffee with the electric coffee brewing machine; and discarding the disposable brew basket after the single cup of coffee has been brewed. The electric coffee brewing machine has a cold water reservoir, an electric heating element for heating the water, and a basket receiving recess. The disposable brew basket has a bottom wall and at least one side wall extending generally upwardly from the bottom wall to define a brewing reservoir for receiving heated water from the electric coffee brewing machine. The bottom wall of the basket has at least one port located in a central portion thereof to permit brewed coffee to flow from the disposable brew basket. The disposable brew basket is inserted into the basket receiving recess of the electric coffee brewing machine before brewing.

U.S. Pat. No. 4,867,993 discloses a disposable beverage brewing chamber is usable in a conventional coffee or other hot beverage brewing and dispensing machine and includes a preferably inverted frusto-conical or rectangular container fabricated of paper, paperboard or the like and having a closed bottom with central liquid beverage dispensing aperture therein; closed vertically collapsible sidewalls and an open top defining a central cavity therewith. The cavity contains a filter bag holding brewable ground coffee or tea leaves or shreds or coffee substitute, herbal tea or the like and is positioned against the bottom aperture. Peelable strips may seal the top and bottom aperture. The top includes a single peripheral slide guide rim in the case where the container has a round or oval top, and a pair of slide guide rims at opposite sides where the top is square or rectangular. The sidewalls are accordion pleated or telescopable. The container may include a handle which can be collapsible, as can the rim(s) to provide the chamber with a compact storage configuration.

### BRIEF SUMMARY OF THE INVENTION

In an exemplary embodiment, a reusable water filter cartridge includes a top portion; a bottom portion; a disposable element including a treatment material; and a connection mechanism to secure the top portion to the bottom portion and to seal the disposable element within the top portion and the bottom portion such that substantially all water entering the top portion is subjected to the treatment material as it flows to an exit in the bottom portion. The disposable element includes one or more o-rings operable to create a seal with the bottom portion. Optionally, the connection mechanism includes outer threads on the top portion operable to engage inner threads on the bottom portion. Alternatively, the connection mechanism includes one or more pins on the top portion operable to engage one or more slots on the bottom portion. Further, the connection mechanism can include one or more snaps on the top portion operable to engage one or more slots on the bottom portion. The disposable element can include a molded block. The disposable element can also include a disposable sachet including a flange. The disposable sachet further includes a bottom portion below the flange dimensioned to fit within the bottom portion. The flange is operable to engage a shoulder on the bottom portion to ensure no water by passes the treatment material. The disposable sachet includes a fibrous non-woven material including one of hydrophilic and biodegradable materials. The treatment material can include fine activated carbon impregnated in the disposable sachet. The treatment material further can further include granulated activated carbon media disposed within the disposable sachet. Alternatively, the treatment material can include granulated activated carbon media to remove smells, etc. and/or ion exchange media to remove heavy metals such as lead, arsenic, etc, disposed within the disposable sachet.

In another exemplary embodiment, a reusable water filter cartridge attached to a water faucet includes a faucet portion disposed to a water faucet; a base portion; a molded carbon block including treatment material; and a connection mechanism to secure the faucet portion to the base portion and to seal the molded carbon block within the faucet portion and the base portion. Optionally, the connection mechanism includes outer threads on the faucet portion operable to engage inner threads on the base portion. The molded carbon block can include one or more o-rings attached to a bottom portion of the molded carbon block, wherein the one or more o-rings form a seal with the base portion. The molded carbon block can include a wrapping including a fibrous non-woven material including one of hydrophilic and biodegradable materials. The molded carbon block is replaced one of periodically and after a predetermined number of uses. The molded carbon block includes an opening; wherein the molded carbon block forms a space with interior walls of the base portion; and wherein water from a faucet fills up within the space and is forced through the molded carbon block to the opening.

In yet another exemplary embodiment, a reusable water filter cartridge method includes opening a water filter cartridge including a top portion and a bottom portion; inserting a disposable element including treatment material in the water filter cartridge; closing the water filter cartridge, wherein upon closing the water filter cartridge, a seal is formed between the disposable element and the water filter cartridge to ensure no water pass by; and using the water filter cartridge to filter water.

In still yet another exemplary embodiment, a disposable sachet for use in a gravity flow water system includes a fibrous non-woven material including a flange for securing the disposable sachet in a reusable water filter cartridge; wherein the fibrous non-woven material comprises a treatment material for treating water. The treatment material includes any of fine activated carbon impregnated in the disposable sachet, granulated activated carbon media disposed within the disposable sachet, and an ion exchange media.

In still yet another exemplary embodiment, a molded carbon block for use in a gravity flow or pressure water system includes a block including treatment material and an opening in an interior of the block; wherein the treatment material includes any of activated carbon media and an ion exchange media; and wherein the block is selectively insertable and removable in a reusable water filter cartridge.

### BRIEF DESCRIPTION OF THE DRAWINGS

The present invention is illustrated and described herein with reference to the various drawings of exemplary embodiments, in which like reference numbers denote like system components, respectively, and in which:

FIGS. 1 and 2 illustrate a filter cartridge housing design with a disposable sachet with a threaded design for reusable water filtration according to an exemplary embodiment;

FIGS. 3 and 4 illustrate a filter cartridge housing design with a disposable sachet with a slot/pin design for reusable water filtration according to an exemplary embodiment;

FIGS. 5 and 6 illustrate a filter cartridge housing design with a disposable sachet with a snap design for reusable water filtration according to an exemplary embodiment;

FIG. 7 illustrates a cross-sectional view of a dome portion engaged to a base portion with a disposable sachet according to an exemplary embodiment;

FIG. 8 illustrates a filter cartridge housing design with a disposable sachet for attachment to a faucet according to an exemplary embodiment;

FIG. 9 illustrates a molded carbon block configuration for use in a reusable filter cartridge according to an exemplary embodiment;

FIG. 10 illustrates a molded carbon block configuration for attachment to a water faucet according to an exemplary embodiment;

FIGS. 12-14 illustrate a reusable filter cartridge according to an exemplary embodiment;

FIGS. 15-17 illustrate cross-sectional views of the reusable filter cartridge of FIGS. 12-14 according to an exemplary embodiment; and

FIG. 18 illustrates testing results for chlorine removal with the disposable sachet in the reusable filter cartridge according to an exemplary embodiment.

### DETAILED DESCRIPTION OF THE INVENTION

In various exemplary embodiments, the present invention provides reusable water filter systems and methods by modifying the design of a plastic housing in such a way so that a disposable sachet with treatment media can be used in it without allowing any bypassing of the untreated water. Advantageously, the present invention solves the problem of disposing of millions of plastic pitcher filter cartridges. The present invention includes a plastic filter cartridge housing design in such a way that it can be reused by situating a treatment media in the form of a disposable media sachet or pod, as is done in certain coffee brewing devices, or in the form of a molded block. However, because water filters require zero by-pass of the water through the treatment material, the present invention includes sealing of the media sachet or pod and molded block to the plastic housing in such a way as to prevent any by-pass of water and to ensure that all the water goes through treatment media and is filtered and treated in its entirety.

The disposable sachet is made in such a way so that it has a pouch where media is stored and has a closed porous upper part that has a flange that rests on the above mentioned shoulder. The upper part of the housing which is perforated to allow water to enter is in a shape of a dome which has at its bottom periphery an outside screw thread. This dome top can then be securely threaded on the shoulder of the lower part of the housing creating a secure water tight seal by pressing tightly against the flange at the top of the sachet. No bypass of water will be possible, and all the water has to enter through the top of the sachet through the treatment media down to the reservoir of the pitcher, i.e. through gravity. The sachet is constructed of a fibrous non-woven material including hydrophilic and biodegradable materials if desired. Additionally, the sachet can be impregnated with reacting media such as an activated carbon to remove contaminants in water. Further, the sachet can only include impregnated reacting media and no treatment material inside the sachet other than the impregnated reacting media.

Unlike coffee sachets, the tolerance for by-pass is absolutely zero and the accompanying design of the present invention allows an absolute seal between the sachet and the filter housing. This is accomplished, for example, by having the filter housing in two parts with a connection mechanism forming a seal between the filter housing and the disposable sachet to prevent water by-pass. Alternatively, the present invention can be utilized in water faucets with the two part filter housing forming a seal with a molded carbon block to prevent water by-pass. Further, the molded carbon block can be utilized with the same plastic housing as the sachet, and in the same water pitchers.

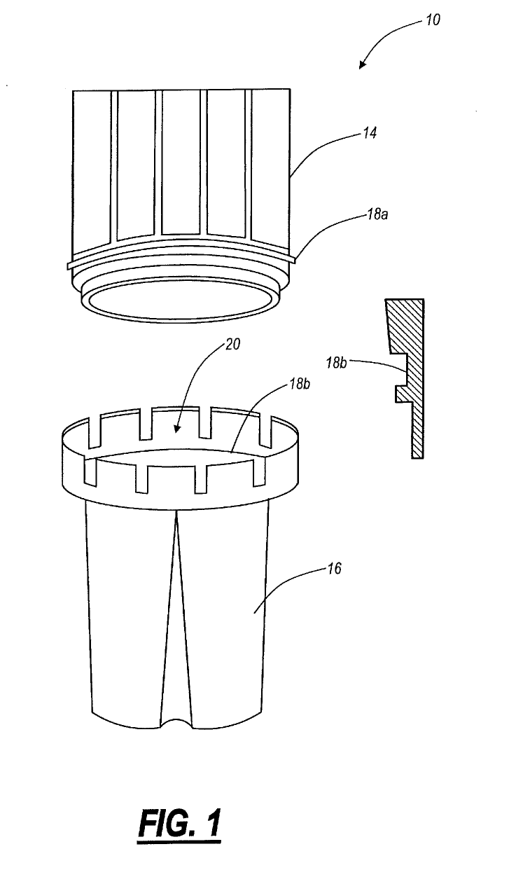

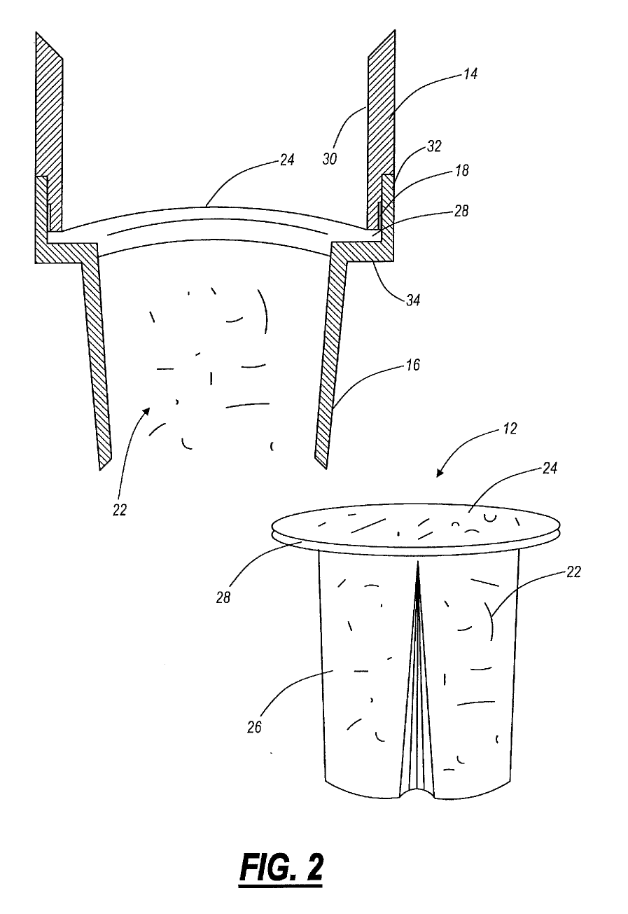

Referring to FIGS. 1 and 2, a filter cartridge housing design 10 with a disposable sachet 12 is illustrated with a threaded design for reusable water filtration according to an exemplary embodiment of the present invention. The filter cartridge housing design 10 utilizes a threaded design where a dome portion 14 is secured to a base portion 16 through inside/outside threads 18a, 18b, as illustrated in FIG. 1. For example, the dome portion 14 can include outside threads 18a which are operable to engage inside threads 18b in the base portion 16. The dome portion 14 is removable from the base portion 16 to provide access to an opening 20 in the base portion 16, e.g., through rotation of the dome portion 14 and/or the base portion 16 to engage/disengage the threads 18a, 18b.

FIG. 2 illustrates the disposable sachet 12 and a cross-sectional view of the disposable sachet 12 engaged to the dome portion 14 and the base portion 16. When the disposable sachet 12 is included in the opening 20 with the dome portion 14 secured to the base portion 16, the filter cartridge housing design 10 is operable to fit within a water pitcher or the like. For example, the water pitcher could include a first section and a second section connected through the filter cartridge housing design 10 with water placed in the first section. Water from the first section flows through the dome portion 14 through treatment material 22 in the disposable sachet 12 and out a plurality of openings in the base portion 16 to the second section. Advantageously, the dome portion 14 and the base portion 16 are reusable by placing a new disposable sachet 12 in the base portion 16 at periodic intervals or after a predetermined amount of use.

The disposable sachet 12 is dimensioned to fit within the opening 20 when the dome portion 14 is disengaged. The disposable sachet 12 includes a porous top portion 24 disposed to a cylindrical portion 26. The cylindrical portion 26 includes the treatment material 22, e.g., the treatment material 22 can include granular activated carbon filtering and the like. The cylindrical portion 26 includes a shape substantially similar to a shape of the opening 20 of the base portion 16. The porous top portion 24 extends to a flange 28 which overhangs the cylindrical portion 26.

The flange 28 is configured to secure the disposable sachet 12 within the dome portion 14 and the base portion 16. For example, walls 30 on the dome portion 14 can include the threads 18 which engage to corresponding threads 18 on walls 32 on the base portion 16. The base portion 16 can include a shoulder 34 on which the flange 28 is disposed on top of when the disposable sachet 12 is engaged in the base portion 16. Accordingly, the walls 30 of the dome portion 14 can make contact with and secure the disposable sachet 12 through the flange 28 as the dome portion 14 is rotated into contact with the base portion 16 through the threads 18, i.e., twisting of the dome portion 14 and/or base portion 16 through the threads 18 seals and secures the flange 28 and the disposable sachet 12 within the dome portion 14 and the base portion 16. Advantageously, this ensures all water entering the dome portion 14 passes through the disposable sachet 12 through the upper porous top portion 24 and the corresponding treatment material 22 and a lower porous bottom portion of the disposable sachet 12.

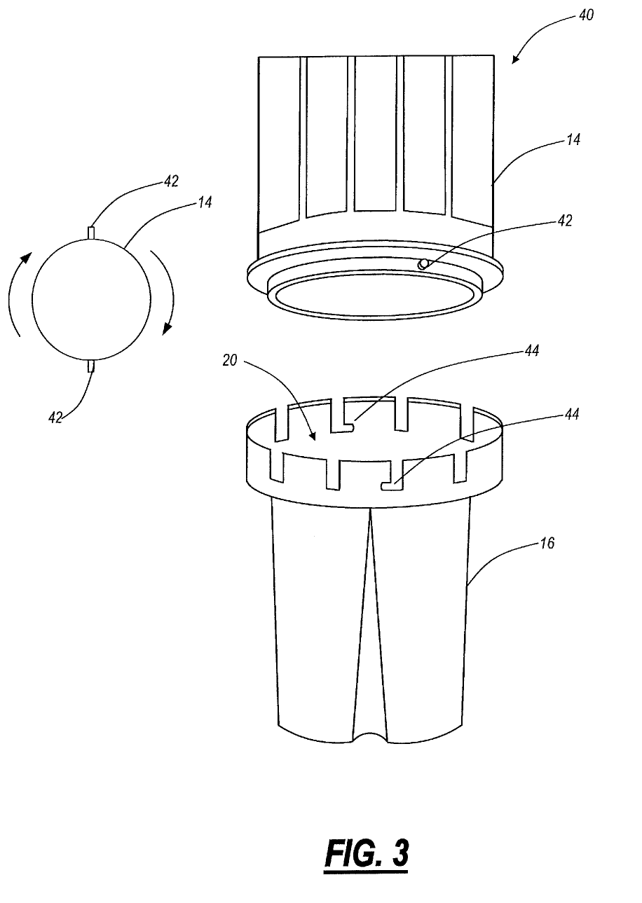

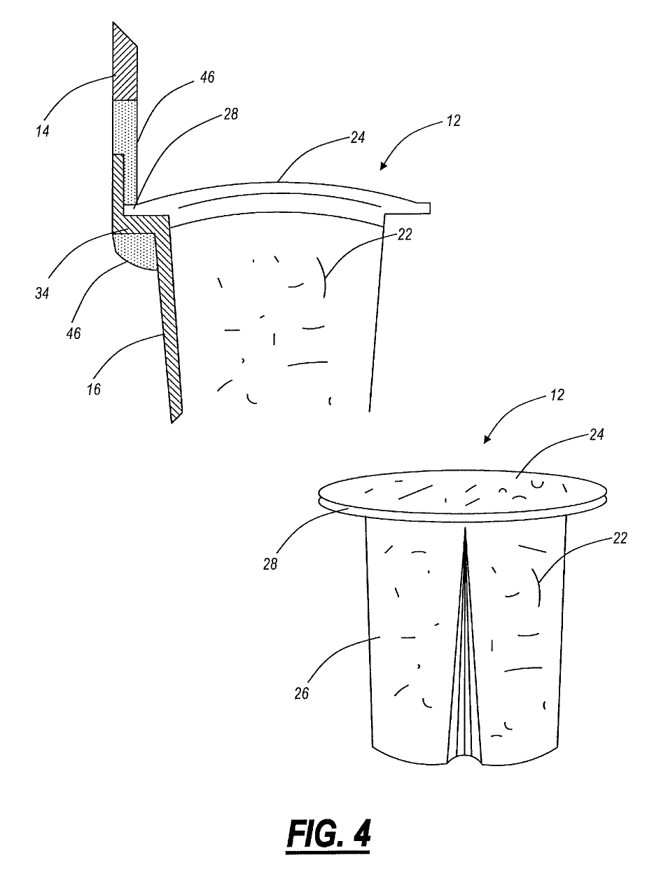

Referring to FIGS. 3 and 4, a filter cartridge housing design 40 with a disposable sachet 12 is illustrated with a slot/pin design for reusable water filtration according to an exemplary embodiment of the present invention. The filter cartridge housing design 40 utilizes a slot/pin design where a dome portion 14 is secured to a base portion 16 through one or more pins 42 on the dome portion 14 that engage one or more slots 44 on the base portion 16, as illustrated in FIG. 3. The dome portion 14 is removable from the base portion 16 to provide access to an opening 20 in the base portion 16, e.g., through rotation of the dome portion 16 and/or the base portion 14 to engage/disengage one or more pins 42 from the one or more slots 44.

FIG. 4 illustrates the disposable sachet 12 and a cross-sectional view of the disposable sachet 12 engaged to the dome portion 14 and the base portion 16. When the disposable sachet 12 is included in the opening 20 with the dome portion 14 secured to the base portion 16, the filter cartridge housing design 40 is operable to fit within a water pitcher or the like. For example, similar to the filter cartridge housing design 10 in FIGS. 1 and 2, the water pitcher could include a first section and a second section connected through the filter cartridge housing design 40 with water placed in the first section. Water from the first section flows through the dome portion 14 through treatment material 22 in the disposable sachet 12 and out a plurality of openings in the base portion 16 to the second section. Advantageously, the dome portion 14 and the base portion 16 are reusable by placing a new disposable sachet 12 in the base portion 16 at periodic intervals or after a predetermined amount of use.

The disposable sachet 12 is dimensioned to fit within the opening 20 when the dome portion 14 is disengaged. The disposable sachet 12 includes a porous top portion 24 disposed to a cylindrical portion 26. The cylindrical portion 26 includes the treatment material 22, e.g., the treatment material 22 can include granular activated carbon filtering and the like. The cylindrical portion 26 includes a shape substantially similar to a shape of the opening 20 of the base portion 16. The top portion 24 extends to a flange 28 which overhangs the cylindrical portion 26.

The flange 28 is configured to secure the disposable sachet 12 within the dome portion 14 and the base portion 16. For example, a gasket 46 can be included between the dome portion 14 and the base portion 16. The base portion 16 can include a shoulder 34 on which the flange 28 is disposed on top of when the disposable sachet 12 is engaged in the base portion 16. Accordingly, the dome portion 14 can make contact with and secure the disposable sachet 12 through the flange 28 as the dome portion 14 is inserted into and rotated into the one or more slots 44 with the base portion 16 through the one or more pins 42, i.e., twisting of the dome portion 14 and/or base portion 16 seals and secures the flange 28 and the disposable sachet 12 within the dome portion 14 and the base portion 16. Advantageously, this ensures all water entering the dome portion 14 passes through the disposable sachet 12 through the upper porous top portion 24 and the corresponding treatment material 22.

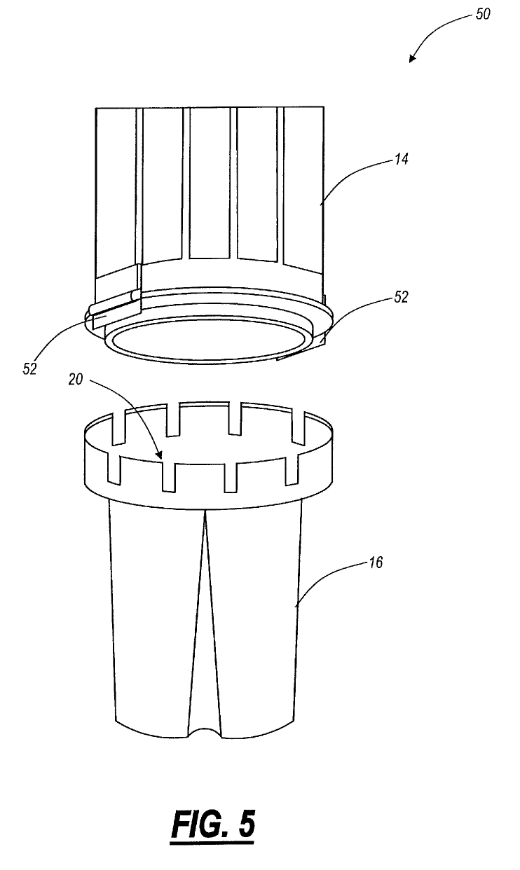

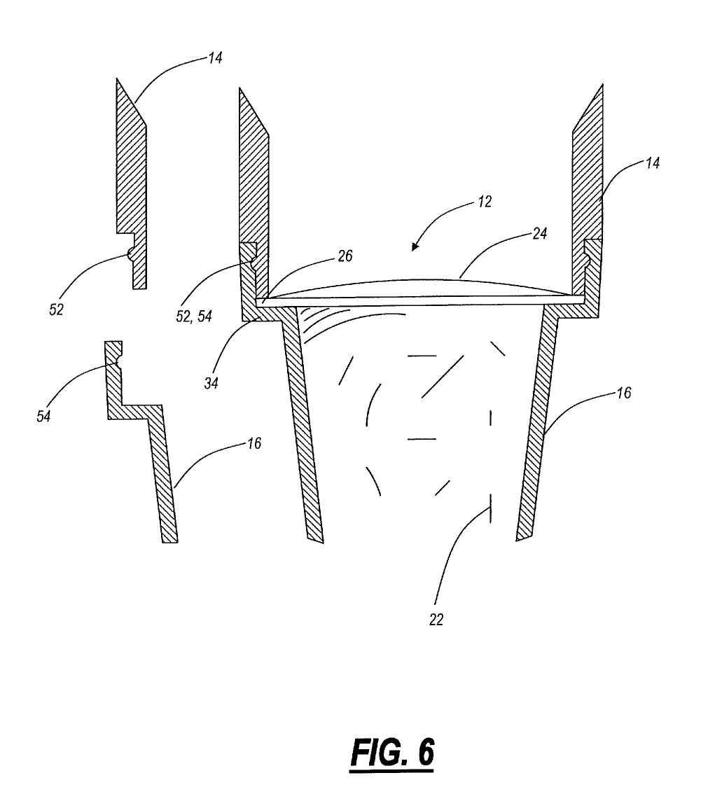

Referring to FIGS. 5 and 6, a filter cartridge housing design 50 with a disposable sachet 12 is illustrated with a snap design for reusable water filtration according to an exemplary embodiment of the present invention. The filter cartridge housing design 50 utilizes a snap design where a dome portion 14 is secured to a base portion 16 through one or more snaps 52 on the dome portion 14 that engage one or more slots 54 on the base portion 16, as illustrated in FIG. 5. The dome portion 14 is removable from the base portion 16 to provide access to an opening 20 in the base portion 16, e.g., through pinching the dome portion 16 and/or the base portion 14 to engage/disengage one or more snaps 52 from the one or more slots 54.

FIG. 6 illustrates the disposable sachet 12 and a cross-sectional view of the disposable sachet 12 engaged to the dome portion 14 and the base portion 16. When the disposable sachet 12 is included in the opening 20 with the dome portion 14 secured to the base portion 16, the filter cartridge housing design 40 is operable to fit within a water pitcher or the like. For example, similar to the filter cartridge housing design 10 in FIGS. 1 and 2, the water pitcher could include a first section and a second section connected through the filter cartridge housing design 50 with water placed in the first section. Water from the first section flows through the dome portion 14 through treatment material 22 in the disposable sachet 12 and out a plurality of openings in the base portion 16 to the second section. Advantageously, the dome portion 14 and the base portion 16 are reusable by placing a new disposable sachet 12 in the base portion 16 at periodic intervals or after a predetermined amount of use.

The disposable sachet 12 is dimensioned to fit within the opening 20 when the dome portion 14 is disengaged. The disposable sachet 12 includes a porous top portion 24 disposed to a cylindrical portion which fits into the base portion 16. The cylindrical portion 26 includes the treatment material 22, e.g., the treatment material 22 can include granular activated carbon filtering and the like. The cylindrical portion 26 includes a shape substantially similar to a shape of the opening 20 of the base portion 16. The porous top portion 24 extends to a flange 28 which overhangs the cylindrical portion 26.

The flange 28 is configured to secure the disposable sachet 12 within the dome portion 14 and the base portion 16. The base portion 16 can include a shoulder 34 on which the flange 28 is disposed on top of when the disposable sachet 12 is engaged in the base portion 16. Accordingly, the dome portion 14 can make contact with and secure the disposable sachet 12 through the flange 28 as the dome portion 14 is inserted into and snapped into the one or more slots 54 with the base portion 16 through the one or more snaps 52, i.e., snapping in the dome portion 14 and/or base portion 16 seals and secures the flange 28 and the disposable sachet 12 within the dome portion 14 and the base portion 16. Advantageously, this ensures all water entering the dome portion 14 passes through the disposable sachet 12 through the porous top portion 24 and the corresponding treatment material 22 and through a porous lower portion of the disposable sachet 12.

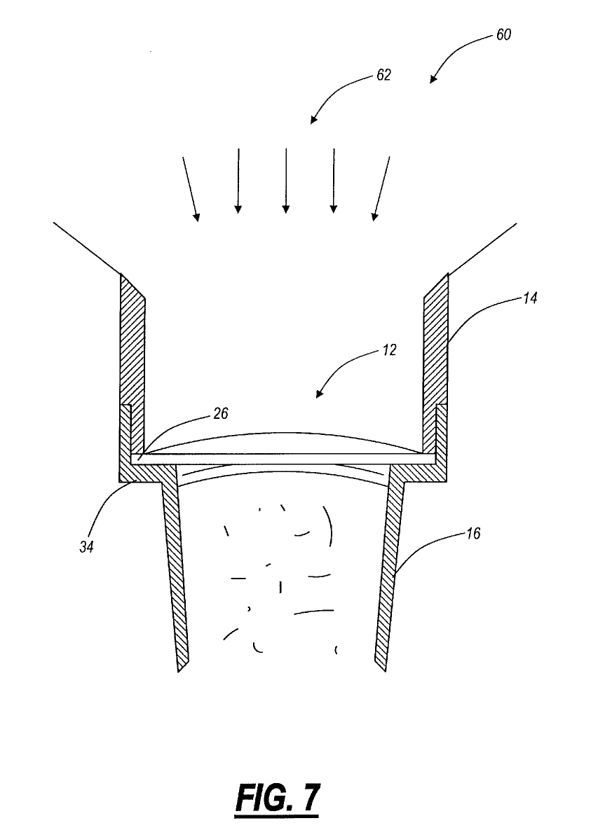

Referring to FIG. 7, a cross-sectional 60 view illustrates a dome portion 14 engaged to a base portion 16 with a disposable sachet 12 according to an exemplary embodiment of the present invention. As described herein, the dome portion 14 and the base portion 16 are reusable. For example, the dome portion 14 and the base portion 16 can include plastic or the like. Of note, the dome portion 14 and the base portion 16 engage the disposable sachet 12 to ensure there is zero by-pass of incoming water 62. This can be accomplished through the flange 26 creating a seal to the dome portion 14 and the base portion 16.

The disposable sachet 12 is made in such a way so that it has a pouch where media is stored and has a closed upper part that has a flange that rests on the above mentioned shoulder 34 and has a porous lower portion of the sachet 12. The dome portion 14 is perforated to allow water to enter. This dome portion 14 can then be securely threaded on the shoulder 34 of the base portion 16 creating a secure water tight seal by pressing tightly against the flange 26 at the top of the sachet 12. Accordingly, no bypass of water is possible, and all the water has to enter through the top of the sachet 12 through the treatment media 22 down to the reservoir of a water pitcher.

Optionally, the disposable sachet 12 can include an o-ring attached on its circumference that allows it to be firmly situated in the upper water reservoir which sits on top of the pitcher reservoir where treated filtered water accumulates. This lower part at its end has a circular shoulder with inside screw threads on the side wall perpendicular to the shoulder.

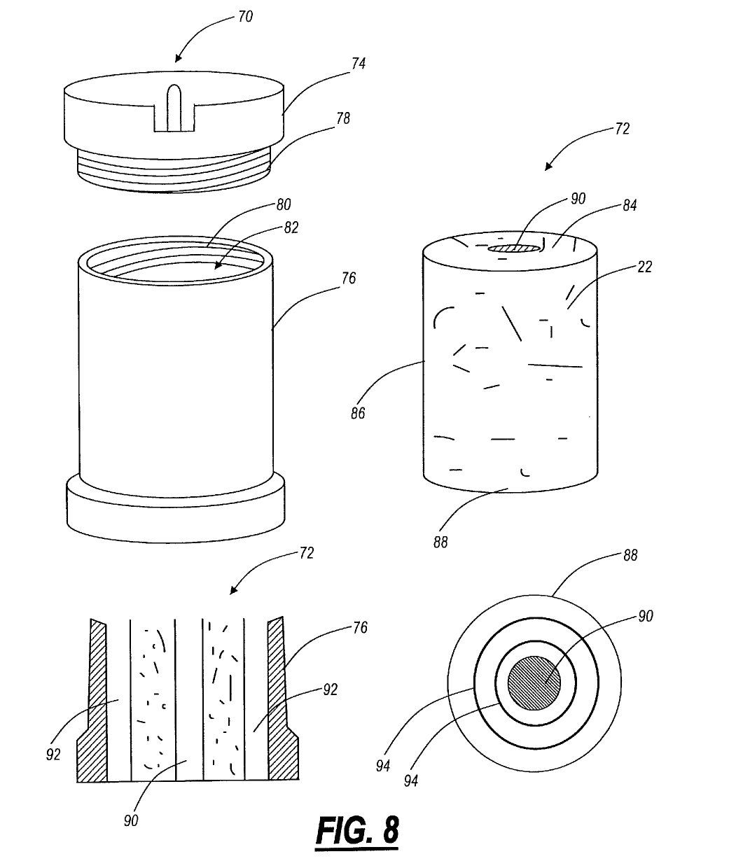

Referring to FIG. 8, a filter cartridge housing design 70 with a molded carbon block 72 for attachment to a faucet is illustrated to provide reusable water filtration according to an exemplary embodiment of the present invention. The filter cartridge housing design 70 utilizes a similar design as the filter cartridge housing design 10, 40, 60 described herein. The filter cartridge housing design 70 can include a faucet portion 74 and a base portion 76 which attaches to the faucet portion 74 through a plurality of outer threads 78 which engage to a plurality of inner threads 80. The faucet portion 74 is configured to connect to a faucet. Advantageously, the faucet portion 74 and the base portion 76 are reusable by placing a new molded carbon block 72 in the base portion 76 at periodic intervals or after a predetermined amount of use.

The base portion 76 includes an opening 82 and the molded carbon block 72 is dimensioned to fit within the opening 82 when the faucet portion 74 is disengaged. The molded carbon block 72 includes a top portion 84 disposed to a porous cylindrical portion 86 and a bottom portion 88 disposed to the cylindrical portion 86 and spaced apart from the top portion 84. The porous cylindrical portion 86 includes the treatment material 22, e.g., the treatment material 22 can include granular activated carbon filtering and the like. Additionally, the molded carbon block 72 includes a cylindrical opening 90 which extends from the top portion 84 to the bottom portion 88 through the entire lengths of the porous cylindrical portion 86. The cylindrical opening 90 allows air and water to flow through the molded carbon block 72.

The molded carbon block 72 is operable to fit within the base portion 76 such that there is a space 92 between the molded carbon block 72 and the interior walls of the base portion 76. The space 92 is filled up by water from the faucet. The top portion 84 is disposed against the faucet portion 74 and the bottom portion 88 is disposed against a bottom of the base portion 76. The bottom portion 88 can include one or more o-rings 94 which form a seal between the bottom portion 88 of the molded carbon block 72 and the base portion 76. Optionally, the base portion 76 includes one or more indentations to receive the one or more o-rings 94. Accordingly, water in the space 92 is forced through the porous cylindrical portion 86 through pressure such that all water from the faucet is treated through the treatment material 22 in the molded carbon block 72. The molded carbon block 72 can include a wrapping of a fibrous non-woven material including hydrophilic and biodegradable materials or a plastic cover with various openings if desired. Advantageously, this prevents a user from coming in direct contact with the treatment material 22 when handling.

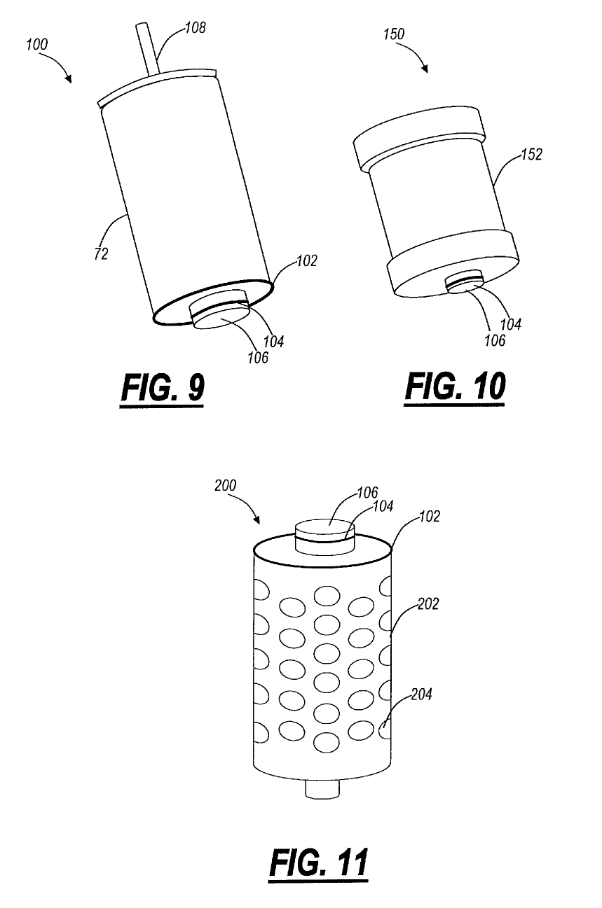

Additionally, the molded carbon block 72 can be utilized in the same exact housing as the filter cartridge housing designs 10, 40, 50 illustrated herein. Advantageously, the filter cartridge housing designs 10, 40, 50 can be utilized with either the disposable sachet 12 or the molded carbon block 72. When used with the filter cartridge housing design 10, 40, 50, the molded carbon block 72 includes an O-ring (illustrated in FIGS. 9 and 11) ensuring substantially all water in the filter cartridge housing design 10, 40, 50 passes through the molded carbon block 72 thereby filtering the water. The density of the treatment material 22 in the molded carbon block 72 may differ depending on whether it is used in a faucet or a pitcher. Specifically, a faucet provides water pressure, and thus the density of treatment material is denser than in a water pitcher configuration where gravity is used to force the water to flow through the treatment material 22.

Referring to FIG. 9, a molded carbon block configuration 100 is illustrated for use in a reusable filter cartridge for a water pitcher, such as the filter cartridge housing designs 10, 40, 50, according to an exemplary embodiment of the present invention. The configuration 100 includes the molded carbon block 72 with the treatment material 22 in the block 72. The configuration 100 further includes two O-rings 102, 104 disposed at a bottom end of the block 72. These O-rings 102, 104 ensure water does not exit the configuration 100 without passing through the carbon block 72. The O-rings 102, 104 ensure water enters into the molded carbon block 72 and exits through an opening 106 at the bottom end thereby passing through the treatment material 22. The configuration 100 also includes a top portion with a vent 108. The vent 108 extends out of the cartridge enabling air to escape from the opening 90 in the molded carbon block 72.

Referring to FIG. 10, a molded carbon block configuration 150 is illustrated for attachment to a water faucet according to an exemplary embodiment of the present invention. The configuration 150 includes an envelope 152 surrounding the molded carbon block 72 and the O-ring 104 at a bottom of the configuration 150 ensuring water does not escape the configuration 150 without being treated through the molded carbon block 72. The envelope 152 can include plastic or a fibrous non-woven material including hydrophilic and biodegradable materials.

Referring to FIG. 11, a molded block configuration 200 is illustrated with a perforated envelope 202 around the molded carbon block 72 according to an exemplary embodiment of the present invention. The configuration 200 can be used in a water pitcher, and the perforated envelope 202 enables handling of the configuration 200 without touching the carbon block 72. The perforated envelope 202 includes a plurality of openings 204 enabling water to enter the block 72. The perforated envelope 202 can include plastic or a fibrous non-woven material including hydrophilic and biodegradable materials.

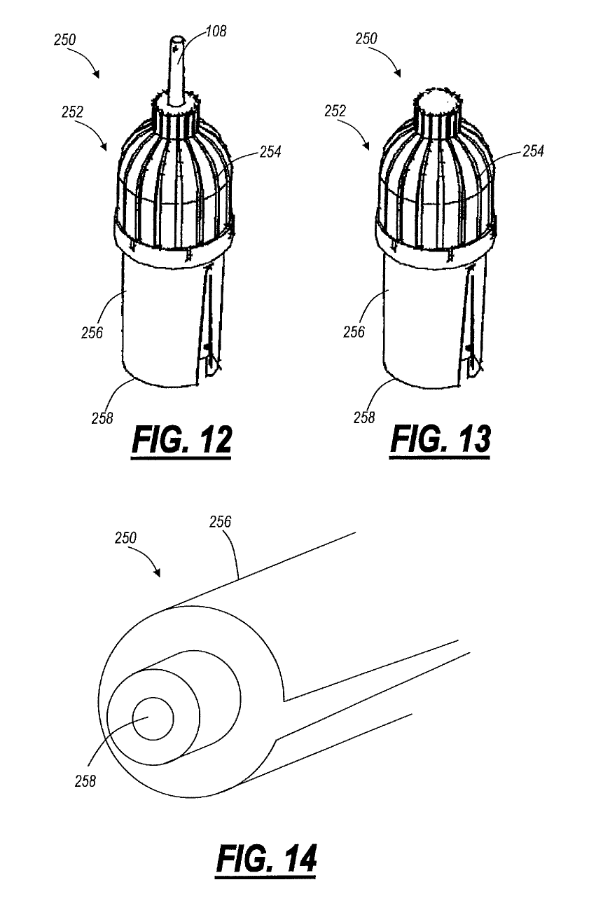

Referring to FIGS. 12-14, a reusable filter cartridge 250 is illustrated according to an exemplary embodiment of the present invention. The reusable filter cartridge 250 can include a molded carbon block as illustrated in FIG. 12 or a disposable sachet as illustrated in FIG. 13 with the same components in the reusable filter cartridge 250. The filter cartridge 250 includes a top portion 252 with a plurality of openings 254 and a bottom portion 256. The filter cartridge 250 is configured for use in a water filtration pitcher that filters water by having two compartments—a top and bottom compartment. The filter cartridge 250 is configured to transfer water between the top and bottom compartment thereby passing the water through a treatment material 22. The top portion 252 is at the top compartment allowing water placed in the top compartment to enter the filter cartridge 250 through the openings 254, and exit through openings 258 at the bottom of the bottom portion 256. The treatment material 22 is disposed within the filter cartridge 250 and by flowing from the openings 254 to the openings 258, the water is treated. The top portion 252 and the bottom portion 256 are selectively removable from one another thereby allowing the disposable of the treatment material 22 as required. In FIG. 12, the treatment material 22 is in the molded carbon block 72, such as illustrated in FIGS. 9 and 11, and with the vent 108. In FIG. 13, the treatment material 22 is in the disposable sachet 12 in the same filter cartridge 250. FIG. 14 illustrates the bottom of the bottom portion 256 showing the opening 258. Of note, whether the block 72 or sachet 12 is used, water is forced through the treatment material 22 such that substantially all of the water exiting the opening 258 has been treated.

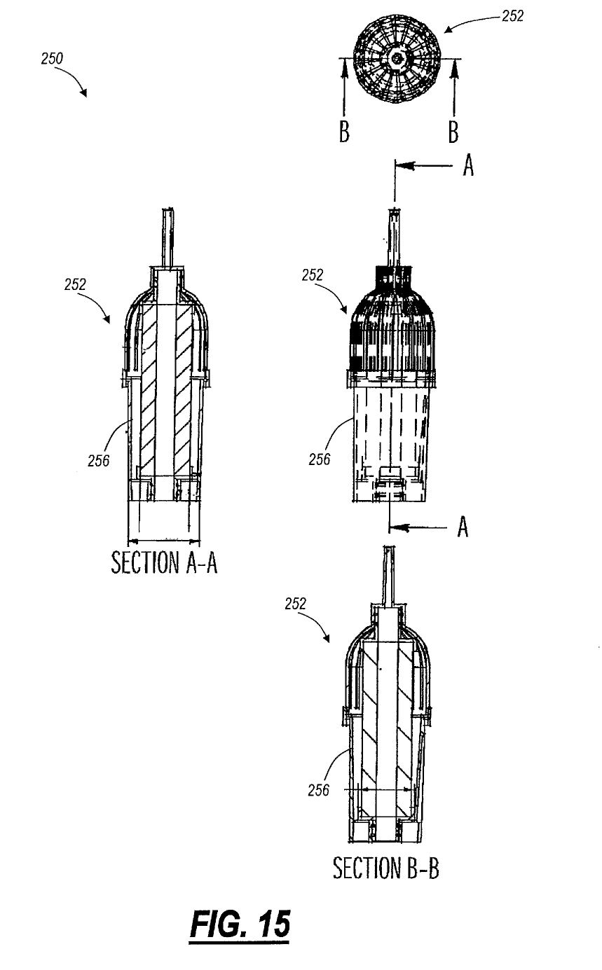

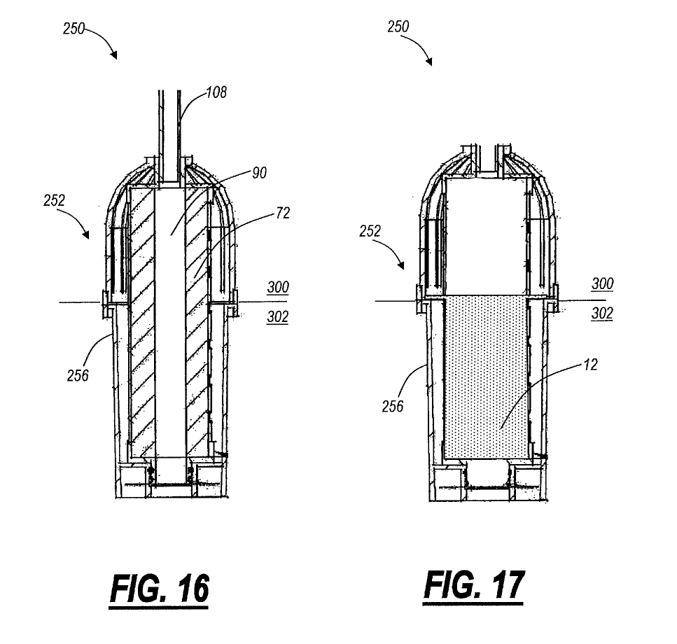

Referring to FIGS. 15-17, cross-sectional views are illustrated of the reusable filter cartridge 250 of FIGS. 12-14 according to an exemplary embodiment of the present invention. FIG. 15 illustrates various cross-sectional views of the reusable filter cartridge 250 with a molded carbon block 72. FIG. 16 illustrates a cross-sectional view of the reusable filter cartridge 250 with a molded carbon block 72, and FIG. 17 illustrates a cross-sectional view of the reusable filter cartridge 250 with a disposable sachet 12. FIGS. 16 and 17 show the filter cartridge 250 with respect to a top compartment 300 and a bottom compartment 302 of a water pitcher. The top portion 252 is substantially in the top compartment 300 and the bottom portion 256 is substantially in the bottom compartment 302. The molded carbon block 72 (FIG. 16) extends through the top and bottom portions 252, 256 of the cartridge. The sachet 12 (FIG. 17) is mostly in the bottom portion 256 with a seal formed by the flange 28 between the portions 252, 256.

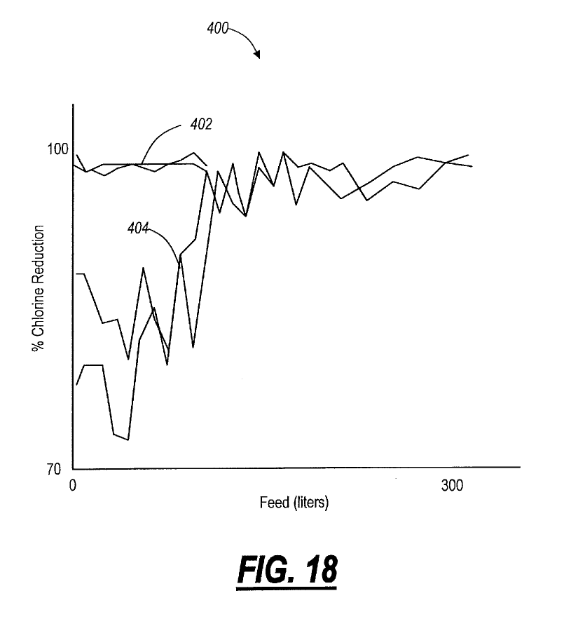

Referring to FIG. 18, a graph 400 illustrates testing results for chlorine removal with the disposable sachet 12 in the reusable filter cartridge 250 according to an exemplary embodiment of the present invention. This testing followed procedure described in NSF/ANSI Standard 42. Here, influent containing 2 ppm of dissolved chlorine is passed through the cartridge and the filtered effluent is tested for chlorine reduction. A minimum of 50% reduction is required for making the claim of chlorine reduction. One of the sachets 12 was filled with 20×50 mesh activated carbon (GAC)—approximately 18 g. One sachet 12 was already impregnated with very fine—Minus 325 mesh activated carbon at 30% of the weight of the cellulose sachet. Duplicate samples were run with and without the GAC granules in impregnated sachets. Lines 402 show two samples of chlorine reduction with GAC granules and with impregnated GAC in the sachet. Lines 404 show two samples of chlorine reduction without GAC granules and with impregnated GAC in the sachet. Note, each of these removed more than 50% of the chlorine, and the sachet without GAC granules also removed more than 70% of the chlorine. Note, if there were any by-pass of the influent solution of the sachet 12 in the reusable filter cartridge 250 such satisfactory results would not have been possible.

Additionally, the molded block 72 with the reusable filter cartridge 250 was also tested to determine its ability to remove lead from pH 8.5 solution using the latest NSF/ANSI protocol for Standard 53. Here, influent containing 150 ppb of colloidal and soluble lead is passed through the cartridge and filtered effluent is measured for its ability to remove total lead to less than 10 ppb. The sample in question passed the test through over 400 liters of solution. This again shows the absence of any pass-by in the system.

In the various exemplary embodiments described herein, the base portions and the dome portions utilize a cylindrical shape. Accordingly, the water pitcher, water faucet, and the like are configured similarly to receive the cylindrical shape. Those of ordinary skill in the art will recognize the base portions and the dome portions also contemplate other shapes, e.g., square, rectangular and the like, with similar shapes for the disposable sachets and molded blocks. Additionally, the sachet is used as an exemplary embodiment, and those of ordinary skill in the art will recognize the present invention contemplates any non-woven device for use with the cartridge, i.e. pod, bag, pouch, basket, and the like.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

1. A reusable water filter cartridge, for use in a gravity flow water system, comprising:
a top portion;
a bottom portion;
a disposable element comprising treatment material;
a connection mechanism to secure the top portion to the bottom portion and to seal the disposable element within the top portion and the bottom portion such that all water entering the top portion is subjected to the treatment material as it flows by gravity to an exit in the bottom portion.

2. The reusable water filter cartridge of claim 1, wherein the disposable element comprises one or more o-rings operable to create a seal with the bottom portion.

3. The reusable water filter cartridge of claim 1, wherein the connection mechanism comprises outer threads on the top portion operable to engage inner threads on the bottom portion.

4. The reusable water filter cartridge of claim 1, wherein the connection mechanism comprises one or more pins on the top portion operable to engage one or more slots on the bottom portion.

5. The reusable water filter cartridge of claim 1, wherein the connection mechanism comprises one or more snaps on the top portion operable to engage one or more slots on the bottom portion.

6. The reusable water filter cartridge of claim 1, wherein the disposable element comprises a molded block.

7. The reusable water filter cartridge of claim 1, wherein the disposable element comprises a disposable sachet comprising a flange.

8. The reusable water filter cartridge of claim 7, wherein the disposable sachet further comprises a bottom part below the flange dimensioned to fit within the bottom portion.

9. The reusable water filter cartridge of claim 7, wherein the flange is operable to engage a shoulder on the bottom portion to ensure no water by passes the treatment material.

10. The reusable water filter cartridge of claim 7, wherein the disposable sachet comprises a fibrous non-woven material comprising one of hydrophilic and biodegradable materials.

11. The reusable water filter cartridge of claim 7, wherein the treatment material comprises fine activated carbon impregnated in the disposable sachet.

12. The reusable water filter cartridge of claim 7, wherein the treatment material comprises granulated activated carbon media disposed within the disposable sachet.

13. The reusable water filter cartridge of claim 11, wherein the treatment material further comprises granulated activated carbon media disposed within the disposable sachet.

14. The reusable water filter cartridge of claim 12, wherein said treatment material also includes ion exchange media.

15. The reusable water filter cartridge of claim 7, wherein said treatment material comprises ion exchange media.

16. A reusable water filter cartridge for attachment to a water faucet, comprising:
a faucet portion fluidly connectable to a water faucet, to let water into and out of said cartridge;
a base portion;
a porous, molded carbon block comprising treatment material;
a connection mechanism to secure the faucet portion to the base portion and to seal the molded carbon block within the faucet portion and the base portion; and
one or more o-rings attached to a portion of the molded carbon block, wherein the one or more o-rings form a seal with the base portion.

17. The reusable water filter cartridge of claim 16, wherein the connection mechanism comprises outer threads on the faucet portion operable to engage inner threads on the base portion.

18. (canceled)

19. The reusable water filter cartridge of claim 16, wherein the molded carbon block comprises a wrapping comprising a fibrous non-woven material comprising one of hydrophilic and biodegradable materials.

20. The reusable water filter cartridge of claim 16, wherein the molded carbon block is replaced periodically and/or after a predetermined number of uses.

21. The reusable water filter cartridge of claim 16, wherein the molded carbon block comprises an opening;
wherein the molded carbon block forms a space with interior walls of the base portion; and
wherein water from a faucet fills up within the space and is forced through the molded carbon block to the opening.

22. A reusable water filter cartridge method, comprising:
opening a water filter cartridge comprising a top portion and a bottom portion;
inserting a disposable element comprising treatment material in the water filter cartridge;
closing the water filter cartridge, wherein upon closing the water filter cartridge, a seal is formed between the disposable element and the water filter cartridge to ensure no water pass by; and
using the water filter cartridge to filter water.

23. A disposable sachet for use in a gravity flow water system, comprising:
a fibrous non-woven material comprising a flange for securing the disposable sachet in a reusable water filter cartridge;
wherein the fibrous non-woven material comprises a treatment material for treating water.

24. The disposable sachet of claim 23, wherein the treatment material comprises any one or more of fine activated carbon impregnated in the disposable sachet, granulated activated carbon media disposed within the disposable sachet, and an ion exchange media.

25. A molded carbon block for use in a gravity flow or pressure water system, comprising:
a block comprising treatment material and an opening in an interior of the block;
wherein the treatment material comprises any of activated carbon media and/or an ion exchange media;
wherein the block is selectively insertable and removable in a reusable water filter cartridge.
